(19) United States
(12) Patent Application Publication
(10) Pub. No.: US 2006/0198858 A1
(43) Pub. Date: Sep. 7, 2006

(54) System and method for effectively controlling household allergens

(76) Inventor: Brittany R. Steinfels, Manchester, NH (US)

Correspondence Address: BRITTANY R. STEINFELS, 1625 PAULE STREET, MANCHESTER, NH, 03104, US

(21) Appl. No.: 11/069,246

(22) Filed: Mar. 1, 2005

(51) Int. Cl. A01N 53/00; A01N 37/34; A01N 25/00

(52) U.S. Cl. 424/405; 514/521; 514/531

(57) ABSTRACT

A system and method of effectively controlling household allergens or pests such as house dust mites or bed mites. The system comprises a container fluidly coupled to a covering, wherein the covering surrounds the household pests' environment. The method for effectively controlling the household pests comprises: surrounding or coupling a covering to a furnishing: connecting a pressurized fluid container to the covering; filling the covering with the fluid in the container; leaving the filled covering for a period of time; and removing the covering. The system and method may be used for pests' environment such as household furnishings.

### FIELD OF INVENTION

The present invention relates to systems and methods of controlling household allergens using a covering filled with at least a pesticide. In particular, the invention relates to systems and methods of effectively controlling household pests by filling a covering surrounding the pests' habitats with compounds such as pesticides, and for significantly reducing the pests' attendant adverse reactions.

### BACKGROUND

Household allergens, including the droppings of pest such as bed mites or house dust mites, are known to facilitate many unhealthy conditions. Recent or past reports, indicating that populations of such pests and subsequently the allergens are increasing in domestic environments, are still prevalent. In addition, current methods of maintaining homes at relatively constant temperature and humidity favor the ideal environment for the growth of these pests.

The pests are scavengers on dead organic matter. Such organic matter includes the shed skin scales of humans or animals. At the home, the shed skin is usually concentrated in furnishings such as beds and the associated bedding articles, or at areas where a pet frequents. The bed and associated bedding articles are optimal environments for the pests because the occupants provide the two elements to create the humid habitats: fluids and the shed skin cells. Regarding the first element, fluid, it is generally known that mammals perspire when they sleep. Certain references suggest that humans excrete ample amounts of fluid when we sleep. The second element that helps to create the ideal humid habitat for the pests is the shed skin scales. The nightly shedding of skin scales and perspired fluids provide a resource for the bed mites to feed.

Household animals can also be a source of allergens. A pet's saliva can cover the pet's shed cells, dander or hair to create an allergen or a resource for the pests to feed on and create more allergens.

Traditionally, methods to control such allergens and/or pests include impregnating the bedding materials or linens with pesticide, and encasing bedding with allergen pest resistant materials. Although, such traditional methods were marginally effective, the effect of prolonged human contact with such pesticides make such methods unappealing to consumers. Furthermore, such methods did not have widespread public or consumer acceptance because of the high initial entrance barrier and subsequent maintenance costs. The initial entrance barrier was high because a consumer had to buy the pest resistant bedding or impregnated bedding to achieve the benefit or limited the consumer's choices. Accordingly, only those buying such new beddings or linens could benefit from such methods. Furthermore, after buying the pesticide impregnated bedding, a consumer may have to keep recharging the pesticide in the bedding to maintain the effect. Similar barriers existed for bedding encased in pest resistant materials.

Other traditional methods for controlling the pests included buying a pesticide and soaking your bedding or linens in a pesticide solution. This method had a wider appeal since new and old consumers could practice it. However, the problem of prolonged human contact with the pesticide was still prevalent. Other drawbacks of the traditional control methods include the diminishing effect of the pesticide resistant bedding. After a period of use, such impregnated bedding had no effect since the pesticide may have a decreased efficacy over time.

Accordingly, there is a need for an easy and consumer-friendly system and method of controlling household allergens, such as pests. Furthermore, the system and methods must be conventional, disposable and adaptable for many other uses.

### SUMMARY OF INVENTION

The present invention provides a system and method of effectively controlling household allergens. The system of controlling household allergens such as pests comprises a container with a fluid and a covering adapted to surround the location of the allergen. The container may be pressurized. The container includes a connector to enable a fluid coupling to the covering. The covering also includes a receptive connector to enable a fluid coupling to the container. The connectors may be quick disconnect couplings. The covering may be adaptably configured or fitted to the bedding to surround the furnishing where the allergen and pests exists. The covering may be semi permeable or permeable such that the contents of the container may fill it and surround the furnishing. In a preferred embodiment, the fluid in the pressurized container is a pesticide. In this embodiment, the pesticide is effective against pests such as house dust mites or bed mites.

The present invention further includes a method of effectively controlling household allergens such as pests. The method of controlling the pests comprises: connecting a pressurized fluid container to a covering; surrounding the furnishing; filling the covering with the fluid in the container; leaving the filled covering for a period of time; and removing the covering. The method may further comprise locally disinfecting the furnishing with a container filled with a pesticide. Further yet, the method may include disinfecting the furnishing or bedding articles or an area after an illness. Alternatively, the method may further comprise filling the covering with a desired fragrance, scent or perfume such that the furnishing or bedding articles acquire the desired perfume, scent or fragrant odor.

### BRIEF DESCRIPTION OF DRAWINGS

FIG. 1 shows an embodiment of the system for effectively controlling the household pests employed to control pests in a furnishing such as a bed;

FIGS. 2A and 2B show a detailed view of the connecting region of the container and the covering of the system embodiment in FIG. 1; and

FIG. 3 shows another embodiment of the system of effectively controlling household pests employed to control pests in a furnishing such as a couch.

### DETAILED DESCRIPTION OF INVENTION

Definitions:

As used herein, the term “furnishing” includes, bedding articles such as mattresses, pillows, bed sheets or linens, cushions, comforters, upholstered portions of beds (such as headboards) or sofas or armchairs and in general any item or component of furnishing in any setting, which may serve as collections areas for the household allergens or habitat for dust mites, or bed mites or pests.

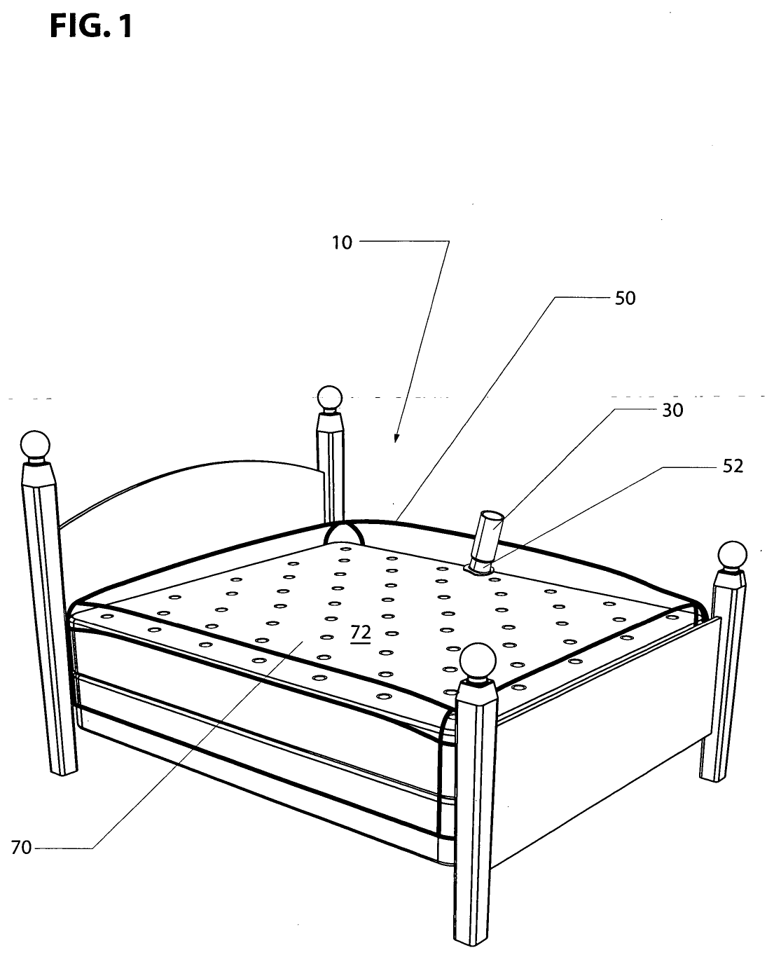

Accordingly, we provide a system and method of effectively controlling household allergens or pests such as house dust mites or bed mites. As shown in FIG. 1, the system 10 includes a container 30 and a covering 50 that can be adapted to surround the pest dwelling 70, such as a mattress of a bed. Once the covering 50 surrounds the pest dwelling, the contents of the container 30 can be released into the covering 50 to control or eliminate the pests.

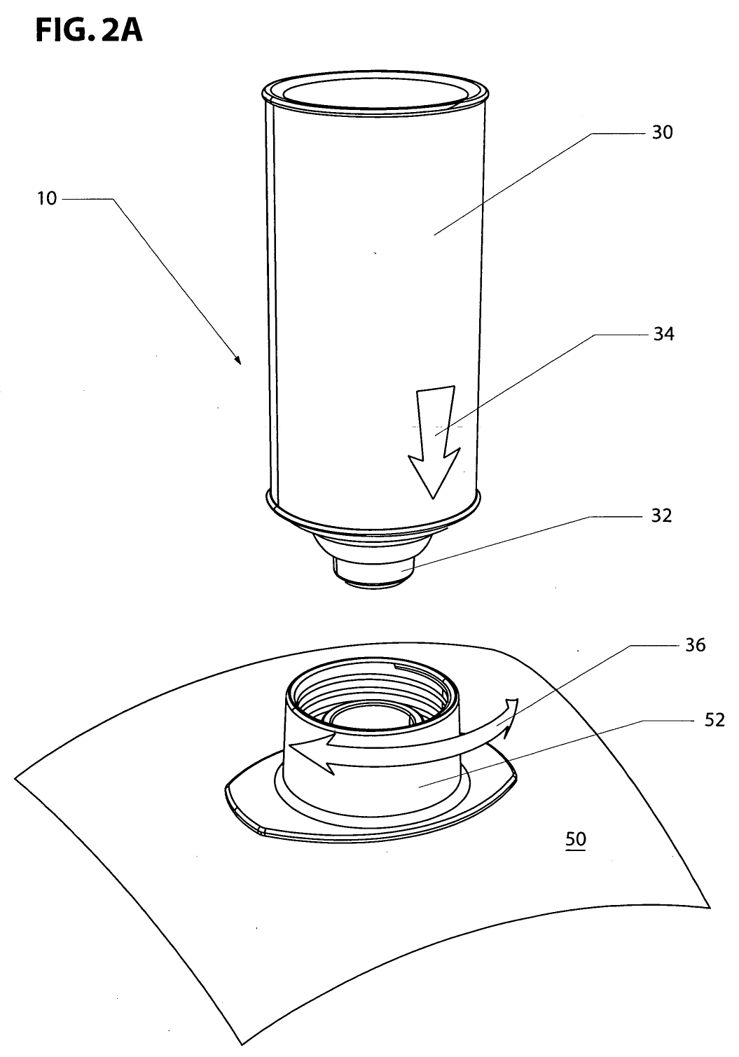

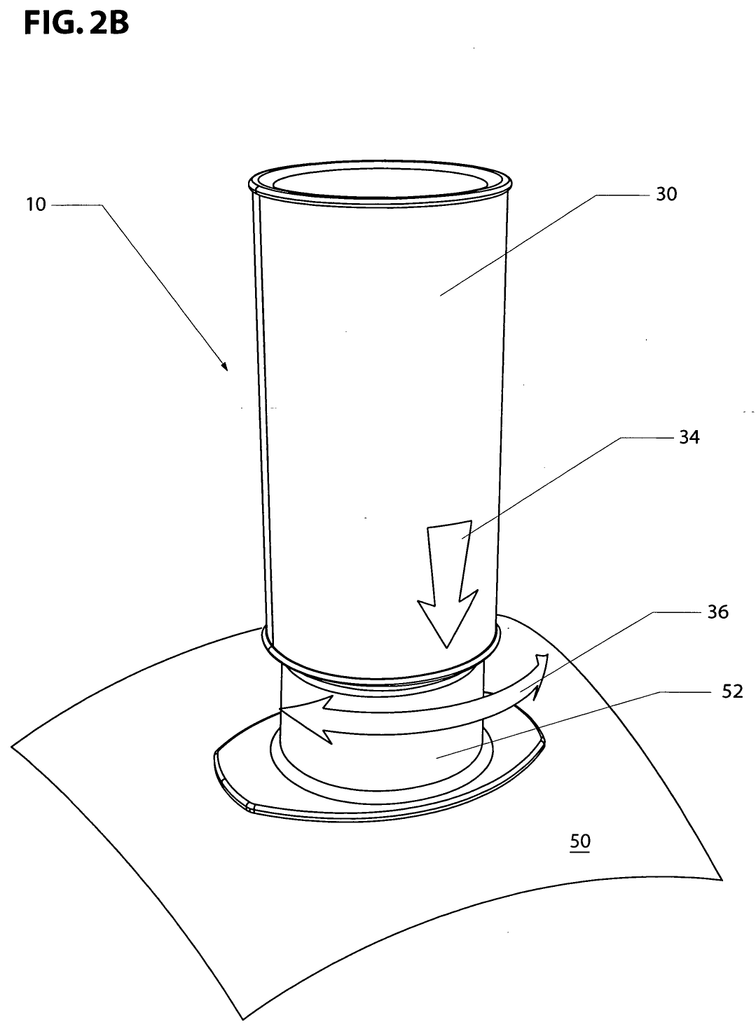

Now referring to FIGS. 2A and 2B, the container 30 may be pressurized with a fluid. The term “fluid” as used herein refers to refers to a liquid, a gas, any mixture of a liquid and a gas, or a liquid entrained with gases and/or solids. The pressurized container 30 may be refillable or disposable. Preferably, the container 30 is disposable and environmentally friendly such as biodegradable and/or recyclable, and a user may obtain a new container whenever necessary. In one embodiment, the fluid in the container 30 is a pesticide. Preferably, the fluid is a substance or combination of substances such as a compound that is effective against mites. In another embodiment, the fluid is an acaricidal agent such as benzyl benzoate. The pesticide may be at least a member selected from a group of pesticides selectively effective against the pests, but may not be harmful or have adverse effects on humans or household pets. Combinations of compounds or substances may be selected to create a more effective pesticide. Preferably, the pesticide is a synthetic pyrethroid such as deltamethrin, sypermethrin, allethrin, or bifenthrin. In a preferred embodiment the synthetic prethroid is premethrin.

Referring back to FIGS. 2A and 2B, the container 30 may have a connector 32 to enable a fluid coupling with the covering 50. The connector may be any length. The connector may be a quick disconnect coupling or connector. In this embodiment, the container may be moved in the direction of the arrows 34 and 36 respectively to fluidly connect to the covering 50 via the covering connector 52. Preferably, the connector 32 may be such that once correctly connected; the contents of the container 30 may be automatically dispensed into the covering 50. Alternatively, there may be a manual dispersion mechanism, wherein a user may have to activate the dispersion of the container's contents once the container 30 is fluidly coupled to the covering 50. In a specific embodiment, the manual mechanism is an activatable switch or tab, which the user can activate to facilitate the dispersion of the container's contents.

FIG. 1 shows an embodiment of the covering 50 included in the system of effectively controlling household allergens such as pests. The covering 50 may be constructed from a material to make it adaptable to surround the pest dwelling. Stated differently, the covering 50 may be adaptably configured to surround the pest's dwelling. In one example where the pests are bed mites in a bedding article such as a mattress 72, the covering 50 may be a fitted covering, like a fitted bed sheet, that can fit around the top and sides of the mattress 72.

Still referring to FIG. 1, preferably, the covering 30 may be used when a user is changing the linens of the bedding article. Alternatively, the covering 30 may be adaptably configured to surround a wholly made bed, wherein the bed includes the other bedding articles such as duvets, pillows and other bedding elements. In other embodiments, the covering may be adapted to cover the entire footprint of the furnishing, including the floor area. In such embodiments, the covering may still be impermeable, thus, the container contents can fill the covering for at least an effective period of time.

The covering 50 may be constructed from a malleable material, such as plastic or fabric, to make the covering 50 semi-permeable or impermeable. The degree of permeability of the covering enables the covering 50 to retain the contents of the container 30 around the pest dwelling such that the pesticide can locally disinfect the targeted region or effectively control the pests and allergen in the targeted region. Additionally, the covering 50 may be constructed from a tear resistant material for longevity. In a specific embodiment the covering is made from the material used for making an inflatable air mattress.

As shown in FIGS. 2A and 2B, the covering 50 includes a receptive connector 52 to enable a fluid coupling with the container 30. In an embodiment, the covering connector 52 is adapted to receive the container 30 and thus facilitate the dispersion of the contents of the container 50, to effectively control the pests. Preferably, the covering connector 52 may be designed such that when the container 30 is properly connected, the container automatically activates the dispersion of its contents. Alternatively, a manual mechanism may be present, wherein, the user may activate the dispersion of the contents of the container after the container is correctly connected to the covering. The connector may be made from an efficient manufacturing process and subsequently coupled to the covering or container. Preferably, the respective connectors for the container or covering are made from the same material and/or manufacturing process for the covering or container. Alternatively, the connector may be made by another manufacturing process. In one embodiment, the connector is made by an injection molding process. Other embodiments may be made from other process such as blow molding. In sum, molding techniques familiar to a person of skill in the art may be used to manufacture the connectors and/or the container and covering of the present invention.

The present invention further includes a method of effectively controlling household allergens such as pests. The method comprises: surrounding or coupling a covering to a furnishing: connecting a pressurized fluid container to the covering; filling the covering with the fluid in the container; leaving the filled covering for a period of time; and removing the covering. The steps of the method may be performed simultaneously and sequentially. Furthermore, a user may perform some or all of the steps of the above method as many times as required to effectively control the pests.

In this method, the step of surrounding the furnishing with the covering is simple. Because the covering may be adaptably configured to surround the furnishing such as a bed, a user simply surrounds the furnishing. As used herein the term “user” refers to any subject that may use the invention.

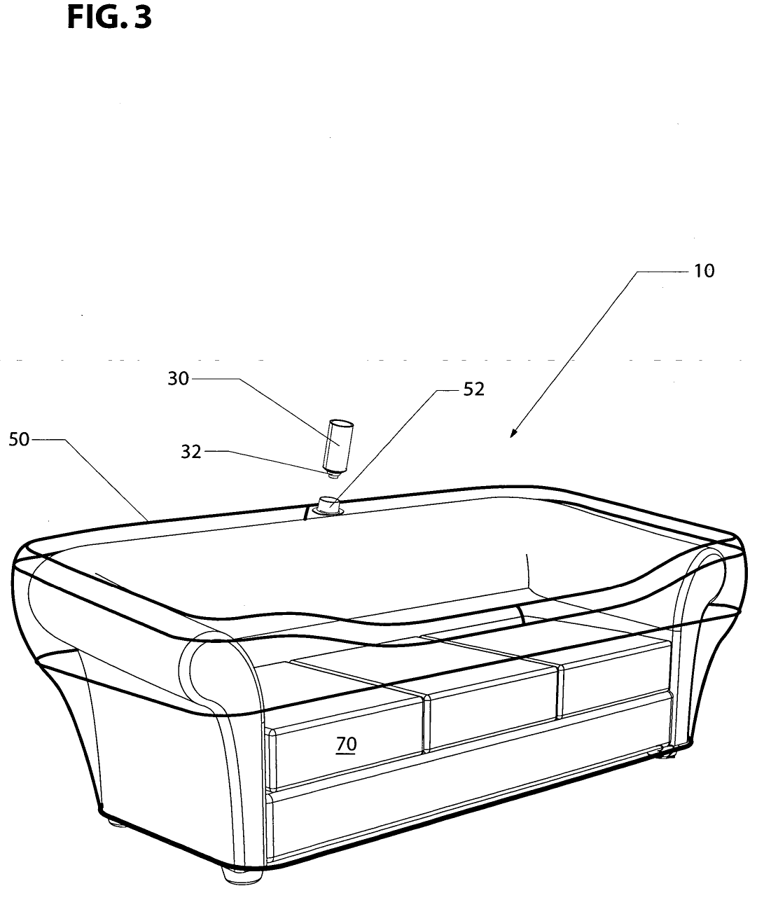

After surrounding the furnishing with the covering, as shown in FIGS. 1 and 3, the next step is to connect the container with the pressurized fluid to the covering. As described earlier, the connectors on both the covering and the container allow the two components to be fluidly coupled. In one embodiment as shown in FIGS. 2A and 2B, connecting the two components, simply comprises inserting the container 30 with a male connecter 32 into the female connector 52 of the covering 50, and twisting the container 50, until the container 30 locks in place. In this embodiment, the connectors may be a luer type connector. Other embodiments may have other types of connectors, such as, quick disconnect couplings or connectors. A person of skill in the art may recognize other types of connectors that may be used.

The next step of the method is to fill the covering with the fluid in the container. In some embodiments, the correct coupling of both components, the container and the covering, activates the dispersion of the container's pressurized fluid. In other embodiments, a user may manually activate the dispersion of the container's contents. Preferably, the correct coupling of the components automatically activate the dispersion of the fluids.

After filling the covering with the container's contents, the user may leave the filled covering for a period of time. The period of time to leave the covering may be specified by a plethora of factors. The factors may be mainly related to the nature of the application and the type of fluid in the container. For example, if the user requires a disinfecting application, the user may have to leave the filled covering for a period whereby the pesticide can be effective. The pesticide manufacturer may suggest an effective disinfecting period. If, however, a user is performing a regular disinfection, such a routine biweekly disinfection of the bedding, the user may leave the filled covering for a relatively shorter period. Furthermore, if a user is using the invention for the application of a desired fragrance or scent, such as a perfume, for example, to achieve a pleasant fragrance in the bedding before setting out for a date, the user may leave the filled covering for still a different period of time. The term perfume refers to any odoriferous material, characterized by vapor pressure less that atmospheric pressure at ambient temperature.

After leaving the filled covering for a specified period of time, the user may remove the covering. In removing the covering, the user simply uncouples the covering from the furnishing or bedding. The step of removing the covering may further comprise uncoupling the container from the covering after removing the covering from the furnishing.

The method described herein may be used in a variety of applications. In a preferred application, a user can locally disinfect a furnishing such as a bed, to effectively control the pests. In this application, the user employs the method when the user is changing the linens of the bed. Alternatively, the user can cover the whole bed or furnishing, including the pillows, blankets, etc, with the covering to disinfect the whole furnishing region. In a similar application, a user may use a fragrant or perfumed fluid to achieve the desired scent. The application wherein the covering is used to cover the whole bed or furnishing, and thus disinfect the whole bed region, may be used in places such as hotels, hospitals or nursing homes, where clean and pest-free environments are desired.

1. A system of effectively controlling household allergens such as pests, the system comprising:
a container with a fluid;
a covering adapted to surround a furnishing and fluidly coupled to the container; and
at least a connector to fluidly couple the container and the covering.

2. The system of claim 1, wherein the container is pressurized.

3. The system of claim 2, wherein the coupling of the container and covering activates an automatic dispersion of the contents of the container.

4. The system of claim 2, wherein a user activates the dispersion of the contents of the container after the fluid coupling of the container and covering.

5. The system of claim 2, wherein the fluid in the container is a pesticide.

6. The system of claim 2, wherein the fluid is an acaricidal agent.

7. The system of claim 6, wherein the fluid is benzyl benzoate.

8. The system of claim 5, wherein the pesticide is at least a member of the group of synthetic pyrethroids consisting of deltamethrin, sypermethrin, allethrin, bifenthrin and premethrin.

9. The system of claim 5, wherein the pesticide fills the covering to effectively control the pests.

10. The system of claim 2, wherein the fluid is a fragrance.

11. The system of claim 10, wherein the fragrance freshens the surrounding ambient atmosphere.

12. The system of claim 10, wherein the fragrance has a scent to activate the senses.

13. The system of claim 12, wherein the scent of the fragrance is any desired scent.

14. The system of claim 1, wherein the covering is impermeable to hold the fluid for at least a desired time to achieve the desired effect.

15. The system of claim 1, wherein the covering can keep the fluid for a desired period to enable an effective control of the pest.

16. The system of claim 1, wherein the covering is semi-permeable.

17. The system of claim 1, wherein the covering enables the local disinfection of the pest dwelling.

18. The system of claim 1, wherein the pest dwelling is a furnishing.

19. The system of claim 1, wherein the pest dwelling is a bedding article.

20. The system of claim 1, wherein the connector is manufactured by a molding process.

21. A method of effectively controlling pests, the method comprising:
surrounding a furnishing with a covering;
connecting a fluid container to the covering;
filling the covering with the fluid in the container;
leaving the filled covering for a period of time; and
removing the covering.

22. The method of claim 21, wherein the container is pressurized.

23. The method of claim 21, wherein the fluid in the container is pesticide.

24. The method of claim 21, wherein the fluid in the container in an acaricidal agent.

25. The method of claim 24, wherein the acaricidal agent is benzyl benzoate.

26. The method of claim 21, wherein connecting the fluid container to the covering further comprises activating a mechanism to disperse the contents of the container into the covering.

27. The method of claim 26, wherein the activation mechanism is automatic such that the correct coupling of the container connector with the covering connector activates the dispersion mechanism.

28. The method of claim 26, wherein the activation mechanism is manual such that the user activates the dispersion mechanism after the correct coupling of the container connector and the covering connector.

29. The method of claim 21, wherein the method is used for disinfecting a bedding article.

30. The method of claim 21, wherein the method is used for making a furnishing acquire 3a desired fragrance.
